(19) United States
(12) Patent Application Publication
(10) Pub. No.: US 2025/0058327 A1
(43) Pub. Date: Feb. 20, 2025

(54) METHOD AND SYSTEM FOR BENEFICIATION

(71) Applicants: EESTECH INC, Lewes, DE (US); EESTECH EUROPE HOLDINGS BV, Amsterdam (NL)

(72) Inventors: Chad Daniel LEHMAN, Elkhart, IN (US); Murray James BAILEY, Auckland (NZ)

(21) Appl. No.: 18/721,179

(22) PCT Filed: Jul. 19, 2022
(86) PCT No.: PCT/IB2022/056624

§ 371 Date: Jun. 17, 2024

(30) Foreign Application Priority Data
Dec. 17, 2021 (GB) 2118460.1

(51) Int. Cl. B02C 4/30; B02C 23/12; C22B 1/24

(52) U.S. Cl. CPC B02C 4/305; B02C 23/12; C22B 1/24

(57) ABSTRACT

The present invention relates to a method and system for beneficiation. In particular, it relates to the recovery of alloys, metals, and minerals from mining and process waste, for example, the recovery of ferrochrome (FeCr) from less desirable materials. A product produced by a method of beneficiation discloses comprises a chrome concentrate of 95% chrome units.

### FIELD OF THE INVENTION

The present invention relates to a method and system for beneficiation. In particular, it relates to the recovery of alloys, metals, and minerals from mining and process waste, for example, the recovery of ferrochrome (FeCr) from less desirable materials.

### BACKGROUND

In the mining industry, beneficiation is used to yield a high-grade concentrate for downstream refining of minerals, oxides, or metals and precedes the steps of smelting and refining.

During the process of beneficiation target minerals, oxides, or metals are separated from undesirable elements (known as gangue and comprising e.g. silica, alumina, and other low value materials) in the mined ore body or waste material (such as furnace slag and process tailings). The resulting target concentrate is then further refined.

According to current practice, beneficiation comprises three stages of comminution (the reduction of particle size by crushing, grinding, cutting, vibrating or other means): primary comminution (large crushing) which is usually accomplished with a jaw crusher or an orbital compression cone; secondary comminution (small crushing) achieved in sage mills, cone crushers, or impact crushers; and tertiary comminution (milling) typically done in ball mills or rod mills to produce material below 1 mm.

After comminution is complete, the crushed and milled material is beneficiated (separated) into gangue, middlings (that is, target material that has not been fully liberated from the gangue) and concentrate (the desired target material).

However, such methods are inefficient: the method is slow; it requires substantial electrical energy input; it entails the frequent and expensive replacement of wear liners which leads to down-time in the processing plant; and importantly, the ore and slag is broken inefficiently, that is it is not broken along the boundary lines (such term is used to mean the edges of the materials that make up the agglomerate body). There is thus a lack of full liberation which complicates the downstream beneficiation process.

According to customary practice, methods of crushing and grinding have been based on attrition (the process whereby a mineral is scrubbed by particles impacting each other). However, attrition does not achieve boundary line separation.

In the mining industry, beneficiation is used to yield a high-grade concentrate for downstream refining of minerals, oxides, or metals and precedes the steps of smelting and refining.

During the process of benefaction target minerals, oxides, or metals are separated from undesirable elements (known as gangue and comprising e.g. silica, alumina, and other low value materials) in the mined ore body or waste material (such as furnace slag and process tailings). The resulting target concentrate is then further refined.

According to current practice, beneficiation comprises three stages of comminution (the reduction of particle size by crushing, grinding, cutting, vibrating or other means): primary comminution (large crushing) which is usually accomplished with a jaw crusher or an orbital compression cone; secondary comminution (small crushing) achieved in sage mills, cone crushers, or impact crushers; and tertiary comminution (milling) typically done in ball mills or rod mills to produce material below 1 mm.

After comminution is complete, the crushed and milled material is beneficiated (separated) into gangue, middlings (that is, target material that has not been fully liberated from the gangue) and concentrate (the desired target material).

However, such methods are inefficient: the method is slow; it requires substantial electrical energy input; it entails the frequent and expensive replacement of wear liners which leads to down-time in the processing plant; and importantly, the ore and slag is broken inefficiently, that is it is not broken along the boundary lines (such term is used to mean the edges of the materials that make up the agglomerate body). There is thus a lack of full liberation which complicates the downstream beneficiation process.

According to customary practice, methods of crushing and grinding have been based on attrition (the process whereby a mineral is scrubbed by particles impacting each other). However, attrition does not achieve boundary line separation.

Furthermore, whereas separation of particles by means of gravitational separation is highly efficient for particles with specific gravity differences greater than three, when the different material particles are close in specific gravity, a gravitational separator cannot distinguish between particle size and particle specific gravity. For example, a 100 um particle with a specific gravity of 2 will behave the same as a 200 um particle with a specific gravity of 1. Both particles will experience the same gravitational pull in the separator system as they both have the same mass. This conflict between particle size and particle specific gravity cancels out the gravitational separation system's ability to divide based on specific gravity and limits the efficiency of gravitational separation.

### SUMMARY OF THE INVENTION

The present invention relates to a method and system for beneficiation. In particular, it relates to the recovery of alloys, metals, and minerals from mining waste, for example, the recovery of the ferro alloy ferrochrome (FeCr) from slag.

According to an aspect there is a system of beneficiation comprising a roll crusher comprising hard-facing tiles facing a cylinder. The roll crusher may be a high-pressure roll crusher. Feed material into the roller may include ore, slag, mining waste, or other material having a relatively low concentration of alloys, metals and/or minerals to be recovered. The feed material may be crushed, preferably continuously, using one or more high-pressure roll crushers which comprise hard-facing tiles

Each hard-facing tiles may be polygons or polygonal. They may have all have an even number of sides, or an odd number of sides. All the hard-facing tiles may have the same number of polygon sides. They may have polygon sides which are all equal lengths, or opposite polygonal sides may be equal lengths, or alternating polygonal sides may be equal lengths, or the polygonal sides may have different lengths. All the hard facing tiles may have the same shape, all the hard-facing tiles may have the same size, or some of the hard-facing tiles may have a different shape or size than others. The hard-facing tiles may be square, rectangular, pentagonal, hexagonal, heptagonal, octagonal, or have more sides.

Each hard-facing tile may be adjacent to one or more other hard-facing tile fixed to the cylindrical face of the cylinder. The hard-facing tiles may be adjacent to each other in a pattern which places a side of one hard-facing tile adjacent to a side of another hard-facing tile. Typically, adjacent sides of adjacent hard facing tiles are parallel to each other, though other geometries are possible.

Each hard-facing tile may have alternating ones of its sides adjacent to one side of another hard-facing tile which also has its alternating ones of its sides adjacent to one side of another hard-facing tile. A side which is not adjacent to another tile is at least a side length away from a parallel side of another tile.

All or some of the hard facing-tiles on the cylinder may be in a group forming a pattern of tiles. There may be a group of hexagonal tiles. Each hexagonal tile may have three sides each individually adjacent to one side one of another hexagonal tile which also has three sides each individually adjacent to one side of another hexagonal tile. These sides which are adjacent to a side of another hexagonal tile may alternate with sides that are not adjacent to another tile. A side which is not adjacent to another tile is at least a side length away from a parallel side of another tile. Sides of hexagonal tiles which are not adjacent to a side of other tile may form spaces in the group which are empty of tiles. The spaces may be hexagonal as defined by sides of the hard-facing tiles.

There may be a group of octagonal tiles. Each octagonal tile may have four sides each individually adjacent to one side of another octagonal tile which also has four sides each individually adjacent to one side of another octagonal tile. These sides which are adjacent to a side of another octagonal tile may alternate with sides that are not adjacent to another tile. A side which is not adjacent to another tile is at least a side length away from a parallel side of another tile. Sides of octagonal tiles which are not adjacent to a side of other tile may form spaces in the group which are empty of tiles. The spaces may be square or rectangular as defined by sides of the hard-facing tiles.

Hard-facing tiles near a round edge of the cylinder may be adjacent to three others of the hard-facing tiles. These hard-facing tiles near the round edge may be only adjacent to two others of the hard-facing tiles at a corner of a group of tiles. These hard-facing tiles near the round edge may be only adjacent to three others of the hard-facing tiles.

In this way the tiles are separated by from each other by a gap of separation. The distance of the gap of separation between adjacent sides of the hard-facing tiles may less than 2 mm, 3 mm, 4 mm, 5 mm, or 6 mm.

The high-pressure roll crushers may run continuously for more than 25,000 hours before the rolls must be re-faced with new hard-facing tiles. It is thus an advantage that the present invention enables the minimization of ‘down time’ due to servicing and replacement of liners (for example, run time of more than 25,000 hours, and liner replacement once every 30,000 hours, compared to a run time of 720 to 1,200 hours and liner replacement every 720 to 1,200 hours).

According to an aspect the method of beneficiation comprises running continuously for more than 25,000 hours in between refacing the cylinder of the roll crusher with the hard facing tiles. Crushing may be achieved in a single step by means whereby, in an embodiment, small gaps between hard-facing tiles of a crusher (for example gaps of 6 mm to 4 mm or less) provide biting edges that cut into the feed material, pulling it into the pinch point of the high-pressure crushing rolls. Preferably the maximum dimension of particles in the feed material to the roll crusher is 40 mm, 30 mm, 20 mm, or 400 micrometers or less to aid the pinch points gripping the particles as the roll crusher rips them apart and/or crushes the particles.

There may be a first screen upstream of the roll crusher to prevent pre-milled debris of less than 40 mm, or 30 mm, or 20 mm or 400 micrometer maximum dimension being milled by the roll crusher. The first screen is configured to operate with at least two axes motion at sonic speed. Oversized material may be screened out using the two-axes dry-screening system. Oversized material may be recycled back into a high-pressure roll crusher.

It is an advantage of the present invention that a crushing step consumes less power than the two or three step traditional comminution process, for example, two to three times less power.

Post-milled debris is driven out the exit of the roll crusher. Then there may be a screen for ‘on-spec’ material, for example particles of the post milled debris which have a maximum dimension of less than 600 micrometer, 400 micrometer, or 100 micrometer.

The screen may be a dry screen and/or it may include enclosed screening equipment. Dust may be collected and recycled into the roll crusher. Oversized material may be recycled into the high-pressure roll crusher to effect auto-genius crushing. The on-spec post milled debris may pass through dry screen and carry on into a wet screening apparatus that separates it out into ranges of particle sizes.

A 400% recycling load (such term is used here to refer to the number of times, or average number of times, the material being crushed or milled passes through the comminution process before it is reduced to the desired size) may be run in the high-pressure roll crusher. This induces auto-genius crushing (such term is used to describe material crushing against itself). The auto-genius crushing created by the 400% recycling load of fine material fed back into the incoming pre-milled, pre-crushed feed material to the roll creates particle shaping. This is aided by the maximum dimension of the pre-milled, pre-crushed feed having particle size dimensions of 30 mm. Particle shaping transforms the angular particles into sub-angular particles by rounding off the corners of each particle. This transforms the amorphous glass phase of the feed material, in particular slag, into a valuable foundry sand product. High-pressure roll crushing shatters the gangue and/or amorphous glass slag from a target material along a boundary between these constituent materials which may be minerals and/or metals that make up the feed material. The minerals are thus easier to separate in the beneficiation process.

According to an aspect the method of beneficiation comprises using the roll crusher to break particles of agglomerate along boundary lines intermediate a target material and gangue. The system of beneficiation used by the method may run continuously for more than 25,000 hours in between refacing the cylinder of the roll crusher with the hard facing tiles.

The method may comprise separating particles of post milled debris crushed by the roll crusher into oversize particles having at least a maximum dimension which is preselected and on-spec particles having a lesser maximum dimension and feeding the oversize particles back in with pre-milled debris incoming into the roll crusher to effect auto-genius crushing. There may be a 200%, 300%, 400%, or 500% recycling load of the post milled debris. The method may include using the roller crusher in a single step with or without feedback of post milled material into the incoming material.

The target material may comprise a metallic mineral, native metal, or chrome units or units of other metals. Gangue and/or amorphous glass slag may be ripped, ground, or crushed from the target material along a boundary between them in particles of feed material to the roll crusher by virtue of the hard facing tiles, their hardness, composition, perimeter shape, and/or gap of space between the tile edges.

The screen system may comprise a dual-axes motion at sonic speed to screen the less than 40 mm, 30 mm, 20 mm or 400 um slag from the high-pressure roll crusher. The first screen may be configured to operate on the pre-milled debris in a dry state. Non blinding screens may be employed on several (separate) screening decks simultaneously (for example, four) to achieve a high yield (for example, 400 tons) per hour of dry fine screening. The first screen may comprise a plurality of screening decks each comprising non-blinding screens.

It is thus an advantage of the present invention that there is a five-fold or greater reduction in the timing, energy requirement and cost of a standard dry screening process: for example, standard dry screening would require upwards of 20 screening units to achieve 400 ton per hour; and the oversized post milled material such as over-size slag, ore particles, and/or mining debris is recycled back into the high-pressure roll crusher and effects auto-genius crushing.

There may be a second screen downstream of the roll crusher configured to operate on post-milled debris provided by the roll crusher. The second screen is configured to operate on the post-milled debris in a wet state. The post milled debris may be subjected to a wet screening apparatus directly after roll crushing or after passing through the dry screen in the enclosed screening equipment. The wet screening apparatus may be upstream of gravitational separators which do beneficiation by separating relatively metal rich particles from gangue and middlings.

The second screen may comprise a plurality of decks to separate the post-milled debris into distinct particle size streams each having a particular range of particle sizes. The second screen comprises a plurality of decks to separate the post-milled debris. For example, the wet screening apparatus may comprise a wet, triple-deck screening. The milled slag and, or post-milled debris may be separated into fraction sizes. For example, the post milled debris in which the maximum particle size is 400 mm is separated by the triple-deck into four fraction sizes: 400 um to 300 um; 300 um to 200 um; 200 um to 100 um; and 100 um to 10 um. This creates narrow band widths of particle sizes to overcome the conflict between specific gravity and particle size in a gravitational separation system.

The process may be continuous and there may be a first distinct particle size stream of particles in range of 300 to 400 micrometer maximum dimension, and/or a second distinct particle size stream of particles in range of 200 to 300 micrometer maximum dimension, and/or a third distinct particle size stream of particles in range of 100 to 200 micrometer maximum dimension, and/or fourth distinct particle size stream of particles in a range of 10 to 100 micrometer maximum dimension. For example, the bandwidth of maximum particle size in a stream may be 100 micrometer or 90 micrometer as in the example above. The bandwidth of each stream may be 500 micrometer, or 300 micrometer, or 50 micrometer. All streams may have the same bandwidth, or certain streams may have different maximum particle size bandwidths from the others.

The relatively narrow bandwidth of maximum particle size in each stream compared to the range of particle sizes the post milled material immediately downstream of the roll crusher aids overcoming the conflict between particle size and particle specific gravity that cancels out the ability of a standard gravitational separation system to divide particles based on specific gravity; and the limitation of gravitational separation to materials with specific gravity differences less than three.

There may be a respective gravitational separator downstream of each distinct particle size stream to separate a concentrate from gangue and/or middlings.

For example, the streams of material which have less than 100 um band widths may be fed to dedicated gravitational separators to achieve complete or near complete separation. Desirable materials which may include metallic oxides may be produced. These may be at least 70%, 80%, 85%, 90%, 93%, 95%, 97% or 97% by weight separation of chrome concentrate from the balance of the amorphous glass slag components.

The gravitational separators may apply a gravitational force of less than 100 g's, 200 g's, 300 g's, 400 g's or 600 g's. A concentrate of desirable materials which may include metallic oxides may be produced. A concentrate as a chrome concentrate of at least 95% by weight chrome units may be produced from the gravitational separators. Three phases of chrome units in the post milled debris may be recovered from each stream by the gravitational separator for that stream. For example, the chrome unit phases may be the unconverted Cr₂O₃ ore, a partially reduced chrome phase known as spinal, and, or a fully reduced chrome phase known as ferrochrome metal.

According to an aspect of the method of beneficiation utilizing a system of beneficiation disclosed herein there is a product produced comprising a chrome concentrate of at least 85% to 95% by weight chrome units.

There may be a process water supply configured to wet the post-milled debris upstream of the second screen. The process water supply may comprise a binary compound in water, wherein the binary compound is capable of chemically bonding to the surface of particles of gangue and/or middlings.

A binary compound may be added to the process water used in the wet screening and wet beneficiation process carried out by the gravitational separators. The binary compound may be capable of chemically bonding to the surface of materials, sealing the surface of each particle with a layer of silicate glass. The binary compound may comprise a silicate-based compound.

It is an advantage that such sealing of the surface of each particle prevents the tailing sand particles from leaching residual heavy metals into the environment.

According to an aspect of the method of beneficiation utilizing a system of beneficiation disclosed herein there is a product produced comprising a sand.

It is a further advantage that such sealing of the surface of each particle enables use of the tailing sand in downstream applications. For example, sand produced by means of the method and system disclosed is thermally stable, shaped by the high-pressure roller crusher into sub-angler particles, and sealed by the binary compound and is classified as a non-hazardous material. It can thus be used as a high-value foundry sand.

The binary compound may comprise a dispersant agent. The binary compound may cause particles of less than 600 um, 400 um, 200 um, and, or 100 um to break up and push away from each other while in process water suspension, thus further increasing the efficiency of the gravitational separation process. The process water suspension may comprise the post-milled debris suspended in the process water.

The binary compound might comprise a high alkaline solution that aids in the pH balancing of the plant process water. The high alkaline solution may have a pH of 7.5, 8, 8.5, 9, 10, 11, 12 or higher. It may be sodium hydroxide and mixed with downstream flow from an aqueous chemical storage tank to provide the process water. The process water may then have a pH of 7.1, 7.5, 8, 8.5, 9, 10, 11 or higher when the process water is used with the post milled, post crushed debris.

There may be a de-watering screen to remove water from the concentrate and/or gangue and/or middlings. The recovered target concentrate (for example, FeCr) may be passed through the de-watering screen that de-waters the concentrate down to low moisture content, for example, less than 20% by weight moisture content. A sonic dewatering screen may be used. The recovered water is returned to a water holding tank for recirculation. The water holding tank may be downstream of the aqueous chemical storage tank and/or the binary compound storage tank. Sonic de-watering screens may be used to de-water both the produced target concentrate and the tailing sand. It is an advantage of the use of sonic de-watering screens that the present invention enables a water neutral or water positive process.

A product produced by method of beneficiation utilizing a system of beneficiation described herein may comprise sand. This may be sand derived from tailings. The sand produced may comprise mostly sub-angular particles. The particles may be sealed with a layer of silicate glass.

A product produced by method of beneficiation utilizing a system of beneficiation described herein may comprise a chrome concentrate of at least 95% weight chrome units.

The invention will now be described, by way of example only, with reference to the accompanying figures in which:

### BRIEF DESCRIPTION OF THE FIGURES

FIG. 1 shows a process diagram to use a roll crusher and post milled material enclosed screening equipment in a system and method for beneficiation;

FIG. 2 shows a process diagram to use a feeding and screening apparatus to screen out particle in pre-milled material upstream of the roll crusher shown in FIG. 1;

FIG. 3 shows a process diagram to use a wet screen apparatus downstream of the roll crusher and enclosed screening equipment shown in FIG. 1;

FIG. 4 shows a process diagram to use a beneficiation apparatus comprising gravitational separators downstream of the wet screen apparatus shown in FIG. 3.

FIG. 5 shows a process diagram to use a dewatering apparatus to dry tailing and to dry chrome concentrate downstream of the beneficiation apparatus shown in FIG. 5;

FIG. 6 shows process water storage and treatment apparatus to treat process water with a binary compound and to adjust the alkalinity of the process water;

FIG. 7 shows a roll crusher comprising hard-facing tiles facing a cylinder; and

FIG. 8 shows a group of four of the octagonal hard-facing tiles on the cylinder.

### DETAILED DESCRIPTION OF THE INVENTION

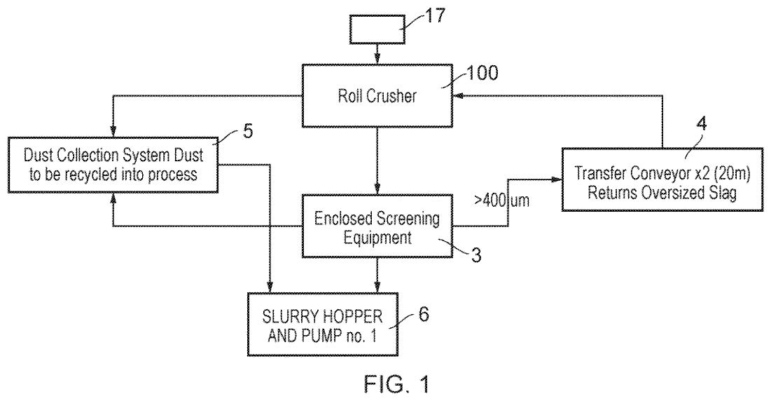

As shown in FIG. 1 a high-pressure roll crusher 100, shatters, crushes, and tears apart the pre-milled materials comprising debris particles amorphous glass slag heterogeneously combined with target constituent materials.

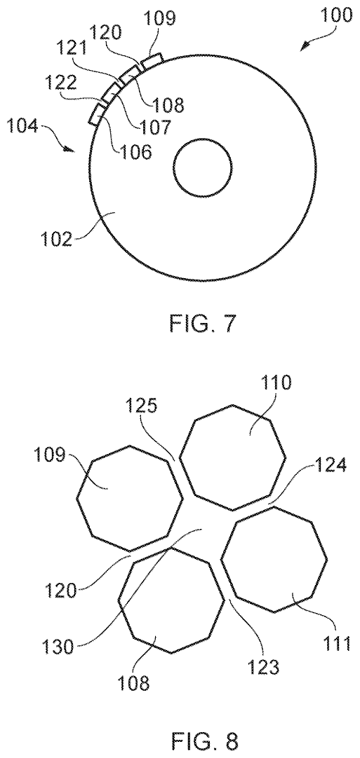

FIG. 7 shows a side view of the roll 102 of the roll crusher 100. On the cylindrical surface of the roll 102 there are shown hard-facing tiles 106, 107, 108, 109. Although the roll is shown with tiles only partially around the circumference for illustrative purposes, there are actually hard-facing tiles all the way around the circumference in some embodiments.

As shown FIG. 8, in between adjacent sides of the tiles 108, 109, 110, 111 there are gaps of separation 120, 123, 124, 125. Each hard-facing tile 106, 107, 108, 109, 110, 111 has alternating ones of its sides adjacent to one side of another hard-facing tile which also has its alternating ones of its sides adjacent to one side of another hard-facing tile. The tiles are octagonal. The sides of the octagonal tiles which are not adjacent to a side of other tile form a space 130 in the group which are empty of tiles. The space is substantially square because the sides are substantially equal length.

Some of the sides of the hard facing tiles 106 106, 107, 108, 109, 110, 111 are parallel or nearly parallel to the axis of the cylinder 102. These sides are straight or nearly straight to conform to the shape of the surface of the cylinder. Other sides of the hard facing tiles 106 106, 107, 108, 109, 110, 111 are parallel or nearly parallel to the circular direction of the cylinder. These sides have an arc shaped cross section profile to conform to the shape of the cylindrical surface 104 of the cylinder 102 to which the hard-facing tiles are attached face to surface.

By virtue of the roll crusher comprising hard-facing tiles facing a cylinder separated by gaps 120, 121, 122, 123, 124, 125 of about, 2, 4, 6, or 8 mm, as the pre-milled material is milled down to 40 mm, 20 mm, 1000 um, 400 um or 100 um in the roller crusher. The debris particles are somewhat or mostly broken apart along the boundary lines between the slag and target materials. The post milled material comprises particles of gangue/slag, middlings, and target materials. This renders the target materials easier to separate from the slag and middling during the downstream beneficiation process.

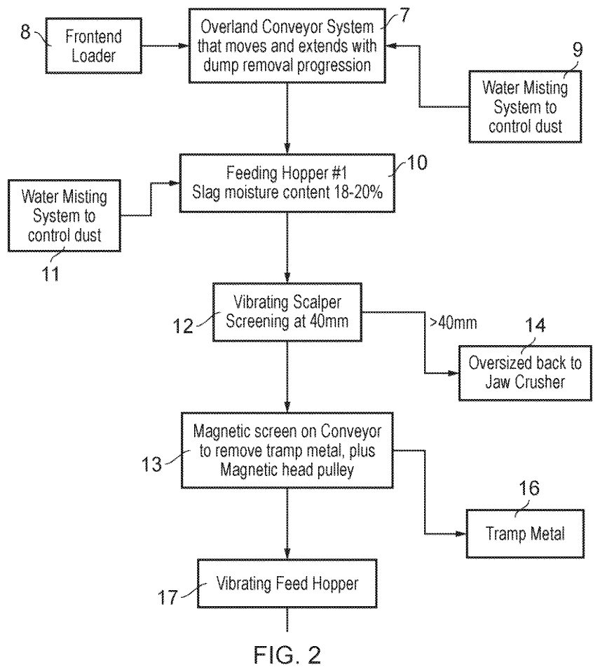

As shown in FIG. 2 upstream of the roll crusher 1, a feed material comprising ore, tailings, mining waste, and/or slag debris is transported on a conveyor system 7 to an in-feed (primary) hopper 10. The conveyor 7 extends as the slag source (for example, a slag dump) is depleted, enabling easy loading of slag by a frontend loader 8. A water misting system 9 sprays on the conveyer system to control dust.

The primary feed hopper 10 is for example a feed hopper of 4 m×4 m. Slag is provided continuously to the processing plant, for example via the primary feed hopper 10 of 4m×4 m providing slag at more than 130 ton per hour.

The in-feed hopper system is equipped with a water misting system 11 to minimize dust generation during loading.

The incoming slag passes through a scalping unit 12 to remove oversized slag and large foreign materials. The oversized slag will be returned to a crushing facility 14 for size reduction.

Particle of the feed material which have a maximum dimension of 40 mm or less pass through the scalping unit 12 to proceed downstream. Then they pass under a magnetic screening system 13 to remove any foreign metal from the feed material. The foreign metal is collected as tramp metal 16 and sent to a local recycling facility.

The feed material sans foreign metal continues downstream via a second vibrating feed hopper 17 to be fed into a dry comminution machine comprising the roll crusher 100 shown in FIG. 1. The pre-milled feed material then becomes post milled material. Post-milled material with a particle size of more than 400 um is screened out by an enclosed screening equipment 3 and transferred by a conveyer 4 back into the roller crusher 100. The comminution process is enclosed and is fitted with a dust collection system 5 to extract all generated dust. Post milled material with a particle size of less than 400 um maximum dimension continues downstream to a slurry hopper 6 urged by a pump number one.

In the dry comminution machine shown in FIG. 1, the ferrochrome slag and/or gangue and/or mining or mill waste is crushed in a single step using the high-pressure roll crusher 1.

FIG. 7 illustrates how the high-pressure roll crusher is equipped with hard-facing tiles on cylinder. FIG. 8 shows a group of the hard-facing tiles on the cylinder. The hard-facing tiles are shown in FIG. 8 as octagonal tiles. There is a less than 2 mm, 3mm, 4 mm, 5 mm, or 6 mm separation of a gap between adjacent sides of the hard-face tiles. The adjacent sides of adjacent hard facing tiles are parallel to each other.

The crushing runs continuously for periods of more than 25,000 hours or more than 30,000 hours. After which the roll crushers are checked and re-faced with new hard-facing tiles. The gap between the hard-facing tiles provides biting edges that cut into the less than 20 mm, 30 mm, or 40 mm maximum dimension particles of pre-milled material and pull it into the ‘pinch point’ of the high-pressure crushing rolls.

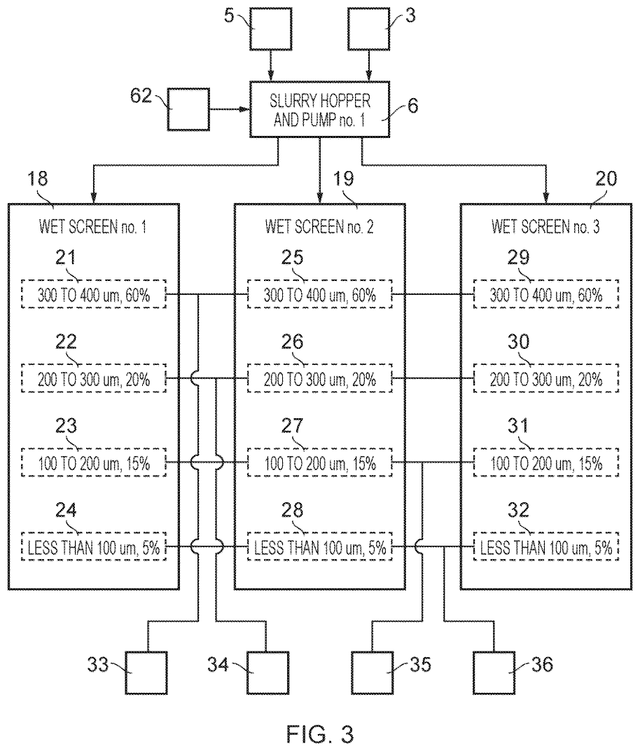

As shown in FIG. 1, a two-axes sonic-dry screening system 3 screens out the oversized material and recycles it back into the high-pressure roll crusher 1. The ‘on-spec’ material, for example material comprising particles of less than 400 um maximum dimension passes through the dry screen 3 and enters a wet screening process shown in FIG. 3. The wet screening process separates the on-spec material into narrow band widths. The wet screening process is accomplished by a wet screen number one 18, a wet screen number two 19 and a wet screen number three 20. The three wet screens 18, 19, 20 process streams in parallel. The screening equipment 3 and transfer conveyer 4 shown in FIG. 1 enables a 400% recycling load in the high-pressure roll crusher 1. This induces auto-genius crushing. The auto-genius crushing via recycling of fine material back into the incoming less than 30 mm pre-milled material effects particle shaping whereby angular particles are transformed into sub-angular particles by rounding off the corners of each particle. This transforms the amorphous glass phase of the slag into a valuable foundry sand product.

The less than 400 um maximum dimension post milled debris passes through the screening system 3 and reports to the slurry hopper 6. The slurry hopper 6 and pump number one is shown in FIGS. 1 and 3.

The two-axes sonic-dry screening system 3 employs non blinding screens on a number of separate screening decks to achieve a capacity of hundreds of tons per hour of dry fine screening: for example, the two axes sonic dry screening system employs non blinding screens on four separate screening decks and achieves a capacity of 400 tons per hour of dry fine screening.

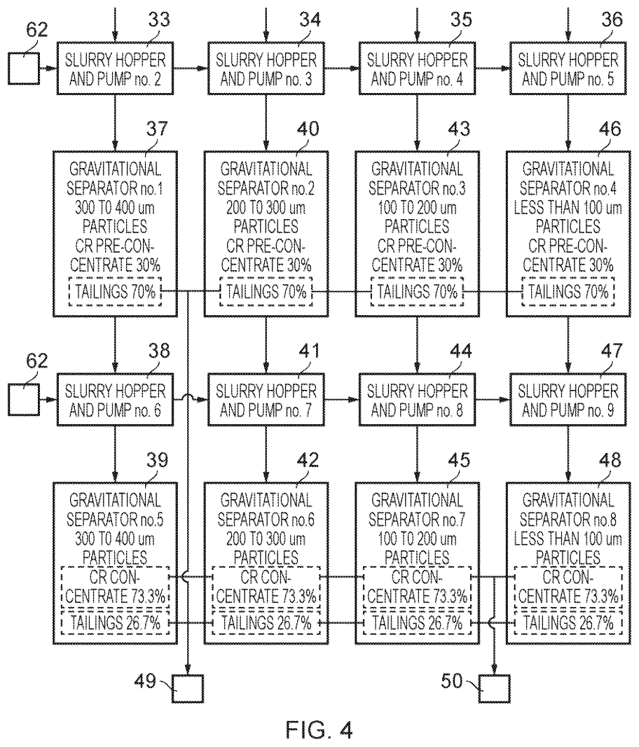

The dry comminution and screening systems 3 are connected to a central dust collection system 5 shown in FIG. 1. The central dust collection system 5 comprises an air/dust separation cyclone and a bag house filtration system. The recovered dust is fed into the slurry hoppers and processed along with the crushed slag in the wet beneficiation system. For example, the dust collection system collects approximately 0.64 tons per hour of fine dust generated by the comminution and screening systems which is transferred to the wet slurry hopper 6 through an in-closed screw conveyor thus preventing the dust from becoming airborne in the plant. The crushed post milled debris and fine dust from the dust collection system is mixed with water in the slurry hopper 6 to form a 40% by weight solids slurry for wet beneficiation. This slurry is continuously agitated and fed to the wet beneficiation circuit shown in FIGS. 3 and 4. The wet screen 18, 19, 20 comprises a wet triple deck. As shown in FIG. 3 the less 400 micrometer maximum particle size post milled debris is separated into different fraction sizes. In some embodiment less than 600 micrometer, 200micrometer, or 100 micrometer maximum particle size post milled debris is separated. For example, in FIG. 3 there are shown four fraction sizes including a first fraction size 21, 25, 29 shown in FIG. 3 of 300 um to 400 um. There is also a second fraction size 22, 26, 30 of 200 um-300 um, a third fraction size 23, 27, 31 of 100 um-200 um, and a fourth fraction size 24, 28 32 of 10 um-100 um. The first fraction size is between 50% and 70% by weight and typically 60%. The second fraction size is between 10% and 30% by weight and typically 20%. The third fraction size is between 5% and 20% by weight and typically 15%. The fourth fraction size is between 1% and 10% by weight and typically 5%. The total is 100% and if for example the first fraction size is 70% one or all the other fraction sizes must nearer the lower end its range accordingly.

Narrow band widths of particle sizes are thus created. The process in continuous so that there is a first stream of 300 um-400 um particles provided to a gravitational separator number one 37 by a slurry hopper and pump number two 33 There is also a second stream of 200 um-300 um particles provided to a gravitational separator number two 40 by a slurry hopper and pump number three 34, a third stream of 100 um-200 um particles provided to a gravitational separator number four 37 by a slurry hopper and pump number five 35, and a fourth stream of 10 um-100 um particles provided to a gravitational separator number four 45 by a slurry hopper and pump number five 36.

In embodiments the post milled debris is provided at less than 1000 micrometer, 600 micrometer, 200 micrometer, or 100 micrometer to the gravitational separators. Then the streams of narrow bandwidth are adjusted. They bandwidths may be adjusted proportionately or by another scheme according to the target material and gangue.

The streams of narrow bandwidth of particle size overcome the conflict between specific gravity and particle size in a gravitational separation system as shown in FIG. 4. Feeding the 100 um or less band widths to dedicated gravitational separators 37, 40, 43, 46, 39, 42, 45, 48 achieves a near complete, or at least greater than 70%, 80%, 85%, 90%, 93%, 95%, 97% or 97% by weight complete separation of chrome concentrate from the balance of the amorphous glass slag components.

Four slurry hoppers and pumps numbers six, seven, eight, and nine 38, 41, 33, 47 supply four individual streams of narrow bandwidth particles to gravitational separator numbers five, six, seven, and eight 39, 42, 45, 48 respectively.

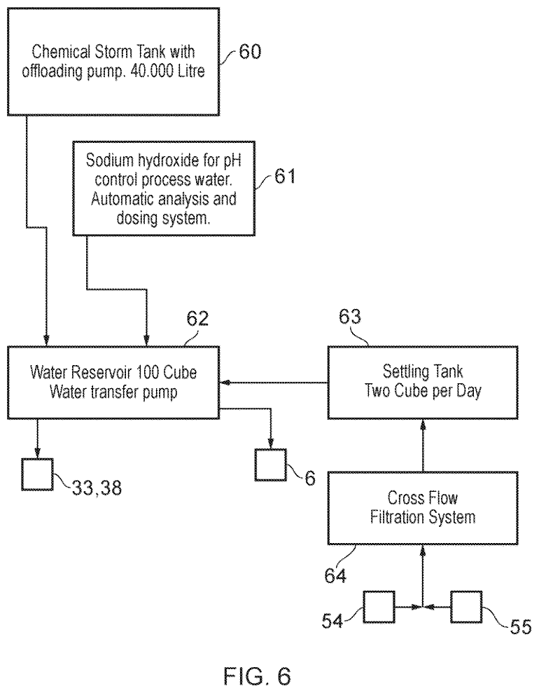

The wet beneficiation circuit shown in FIGS. 3 and 4 uses a 100-cube process water holding tank 62 shown in FIG. 6 to supply the slurry hopper 6 and pump number one with water to create the 40% weight solids slurry for wet beneficiation.

The slurry passes through a number of beneficiation systems, for example, such beneficiation systems, which separate the chrome units from the gangue (tailings) are shown in FIG. 4. In some embodiments there may be up to two, four, six, eight, or ten beneficiation systems.

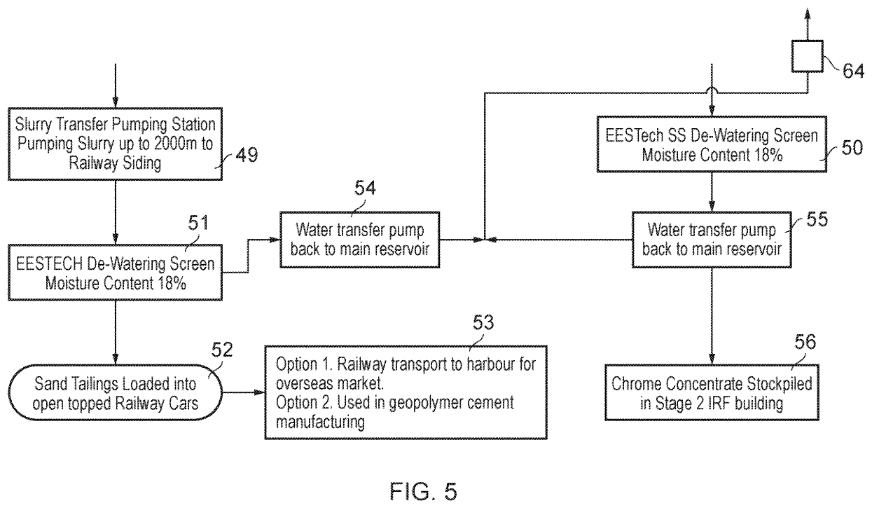

A fifth stream of tailings is drawn from the gravitational separators 37, 40, 43, 46, 39, 42, 45, 48. The fifth stream is channeled to a slurry transfer pumping station 49 shown in FIG. 4 and FIG. 5 and then a first de-watering screen 51 shown in FIG. 5.

A sixth stream of target concentrate is drawn from the gravitational separators 37, 40, 43, 46, 39, 42, 45, 48. The sixth stream is channeled to a second de-watering screen 50 shown in FIG. 4 and FIG. 5.

The process water is monitored for pH and adjusted accordingly, for example with sodium hydroxide 61 shown in FIG. 6, to keep the process water pH neutral to avoid acidity corroding the processing equipment.

In an embodiment, the beneficiation system is a closed loop system set on a concrete floor and surrounded by bunded walls to prevent any spilled process water from escaping into the environment.

The process water is filtered through a crossflow filtration system 64 shown in FIG. 5 and in FIG. 6 to remove ultra-fine particles. The crossflow filters back flush into small settling tanks 63 shown in FIG. 6 where the water is returned to the beneficiation system and the ultra-fines are mixed into the tailings.

The gravitational separators 37, 40, 43, 46, 39, 42, 45, 48 shown in FIG. 4 apply up to 300 gs of gravitational force enabling up to 70%, 80%, 85%, 90%, 93%, 95%, 97% or 97% by weight beneficiation of the chrome units from the amorphous glass slag. The chrome unit phases comprise the unconverted Cr2O3 ore, the partially reduced chrome phase known as spinal, and the fully reduced chrome phase known as ferrochrome metal.

As shown in FIG. 6 a chemical storm tank with off-loading pump 60 supplies a water reservoir with water transfer pump 62. A (silicate-based) binary compound is added to the process water 62 used in the wet screening and wet beneficiation process shown in FIGS. 3 and 4. The binary compound coats the surface of each particle and seals it with a layer of silicate glass. This prevents the tailing sand particles from leaching any residual heavy metals into the environment, allowing the tailing sand to be used in downstream applications. Water transfer pumps 54, 54 shown in FIG. 5 pump water back to the main reservoir 62 via the cross-flow filtration system 64 and settling tank 63.

In an embodiment, the tailing sand shown in FIG. 5 is produced by the ferrochrome slag beneficiation process described herein. It is a high value foundry sand that is thermally stable, comprised of sub-angler particles, sealed by the binary compound, and thus classified as a non-hazardous material. A de-watering screen 51 upstream of railway car loading 52 removes water from the sand down to 18%.

The binary compound is also a strong dispersant agent that causes all the less than 600 micrometer, 400 micrometer, or 100 micrometer maximum dimension particles to break up and push away from each other while in process water suspension. This further increases the efficiency of the gravitational separation process.

The binary compound is a colourless, odourless, high-alkaline solution that aids in the pH balancing of the plant process water. A sodium hydroxide dosing system 61 shown in FIG. 6 also helps to adjust the pH of the plant process water.

The second stage of gravitational separators 39, 42, 45, 48 shown in FIG. 4 provide concentrate of 73% metallic mineral, native metal, or chrome units or units of other metals to a second dewatering screen 50 shown in FIG. 5. In some embodiments the concentrate is 50%, 60%, 70%, 80%, or 90% or more metallic mineral, native metal, or chrome units or units of other metals or target minerals.

The recovered target concentrate 56 (e.g. FeCr) is passed through the sonic de-watering screen 50 that de-waters the concentrate down to 18% by weight moisture content. i.e. equal to or less than the moisture content of the raw slag entering the processing plant. In some embodiments the moisture content is down to 30%, 20%, 10%, or 5% or less by weight. The recovered water is returned to the 100-cube process water holding tank 62 for recirculation by a water transfer pump 55. A water neutral operation or water-positive operation is achieved.

The target concentrate 56 can be stockpiled on a concrete pad that has bunded walls to prevent water runoff and any water that slowly wicks out of the concentrate is returned to the process water circuit.

The target concentrate (e.g. FeCr) is transferred to a drying and blending facility located inside a smelting building for smelting.

The invention has been described by way of examples only. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the claims.

1-30. (canceled)

31. A system of beneficiation comprising a roll crusher comprising a group of hard-facing tiles facing a cylinder.

32. A system of beneficiation according to claim 31 wherein the hard-facing tiles are octagonal.

33. A system of beneficiation according to claim 32 wherein each hard-facing tile has four sides each individually adjacent to one side of another hard-facing tile which also has four sides each individually adjacent to one side of another hard-facing tile;
wherein the sides which are adjacent to a side of another hard-facing tile alternate with sides that are not adjacent to another hard-facing tile; wherein a side which is not adjacent to another hard-facing tile is at least a side length away from a parallel side of another hard-facing tile to form rectangular spaces in the group which are empty of hard-facing tiles.

34. A system of beneficiation according to claim 33 wherein in between the adjacent sides of the hard-facing tiles is a gap of separation, the distance of the gap of separation between adjacent sides of the hard-facing tiles is between 2 mm and 6 mm.

35. A system of beneficiation according to claim 31 comprising a first screen upstream of the roll crusher to prevent pre-milled debris of less than 400 micrometer maximum dimension being milled by the roll crusher.

36. A system of beneficiation according to claim 35 wherein the first screen is configured to operate on the pre-milled debris in a dry state.

37. A system of beneficiation according to claim 31 comprising a second screen downstream of the roll crusher configured to operate on post-milled debris provided by the roll crusher, wherein the second screen comprises a plurality of decks to separate the post-milled debris into distinct particle size streams each having a particular range of particle sizes.

38. A system of beneficiation according to claim 37 wherein the second screen is configured to operate on the post-milled debris in a wet state.

39. A system of beneficiation according to claim 38 comprising a respective gravitational separator downstream of each distinct particle size stream to separate a concentrate from gangue and middlings, wherein each respective gravitational separator is configured to apply a gravitational force of less than 300 g's to produce the concentrate as a chrome concentrate of at least 95% by weight chrome units.

40. A system of beneficiation according to claim 38 comprising a process water supply configured to wet the post-milled debris upstream of the second screen, wherein the process water supply comprises a binary compound in water, wherein the binary compound is capable of chemically bonding to the surface of particles of gangue and middlings.

41. A system of beneficiation according to claim 40 wherein the binary compound comprises a binary silicate-based compound to seal each of the particles of gangue and middlings with a layer of silicate glass.

42. A system of beneficiation according to claim 41 wherein the binary compound comprises a dispersant to cause the particles of gangue and middlings having less than 400 micrometers maximum dimension repel each other in a suspension comprising the process water and post-milled debris.

43. A system of beneficiation according to claim 41 wherein the binary compound comprises an alkaline solution of pH 8, 10, 12 or higher.

44. A product produced by a method of beneficiation using a system of beneficiation according to claim 41 comprising the particles of gangue and middlings sealed with the layer of silicate glass.

45. A product produced by a method of beneficiation using a system of beneficiation according to claim 39 comprising the chrome concentrate of at least 95% weight chrome units.

46. A method of beneficiation using a system of beneficiation according to claim 31 including using the roll crusher to break particles of agglomerate along boundary lines intermediate a target material and gangue, and separating particles of post milled debris crushed by the roll crusher into oversize particles having at least a maximum dimension which is preselected and on-spec particles having a lesser maximum dimension and feeding the oversize particles back in with pre-milled debris incoming into the roll crusher to effect autogenous crushing.
